(19) United States
(12) Patent Application Publication
(10) Pub. No.: US 2019/0265628 A1
(43) Pub. Date: Aug. 29, 2019

(54) IMAGE FORMATION APPARATUS AND METHOD OF DETERMINING DEVELOPER COLLECTION DESTINATION

(71) Applicant: Oki Data Corporation, Tokyo (JP)

(72) Inventor: Hirofumi NAKAJIMA, Tokyo (JP)

(73) Assignee: Oki Data Corporation, Tokyo (JP)

(21) Appl. No.: 16/278,716

(22) Filed: Feb. 19, 2019

(30) Foreign Application Priority Data
Feb. 27, 2018 (JP) 2018-033552

(51) Int. Cl. G03G 15/00

(52) U.S. Cl. CPC G03G 15/556

(57) ABSTRACT

An image formation apparatus according to an aspect of one or more embodiments may include: replacement units, each being replaceable and including an expendable part and a developer collection container; and a determination unit. The determination unit is configured to: acquires an expendable part life progress degree representing a degree of progress in used amount of the expendable part relative to a product life of the expendable part and a collection container capacity progress degree representing a degree of progress in used amount of the developer collection container relative to a capacity of the developer collection container for each of the replacement units; and determines a developer collection container as a developer collection destination out of the developer collection containers of the replacement units, based on the acquired expendable part life degrees and the acquired collection container capacity progress degrees.

### CROSS REFERENCE TO RELATED APPLICATIONS

This application claims priority based on 35 USC 119 from prior Japanese Patent Application No. 2018-033552 filed on Feb. 27, 2018, entitled “IMAGE FORMATION APPARATUS AND METHOD OF DETERMINING DEVELOPER COLLECTION DESTINATION”, the entire contents of which are incorporated herein by reference.

### BACKGROUND

This disclosure relates to an image formation apparatus and a method of determining a developer collection destination, which can be suitably applied to an image formation apparatus including a developer collection unit, for example.

A related image formation apparatus adopting electrophotography includes an image formation unit to form an image by using a toner serving as a developer, a transfer unit, and a waste toner collection container to collect a waste toner (to be described later). In the case of an image formation apparatus adapted to color images, the image formation units are provided for respective colors, and each image formation unit includes a photosensitive drum serving as an image carrier, and a cleaning blade. Each image formation unit forms a toner image on the photosensitive drum by developing an electrostatic latent image formed on the photosensitive drum while using the toner. The transfer unit transfers the toner images formed by the respective image formation units onto a medium such as a sheet of paper.

In the meantime, each image formation unit removes a remaining toner that remains on the photosensitive drum by using the cleaning blade. The image formation apparatus is configured to convey the remaining toners removed from the photosensitive drums of the respective image formation units as the waste toners from the respective image formation units to the waste toner collection container, thus collecting the waste toners into the waste toner collection container (see Patent Document 1 for example).

Meanwhile, there is also an image formation apparatus configured to eject a deteriorated toner generated in an image formation unit onto a photosensitive drum so as to remove the deteriorated toner by using a cleaning blade, and then to collect the deteriorated toner thus removed as a waste toner into a waste toner collection container.

Furthermore, there is also an image formation apparatus in which each of image formation units is provided with a waste toner collection container and a remaining toner and a deteriorated toner removed from each image formation unit are collected as a waste toner into the waste toner collection container in the image formation unit.

Patent Document 1: Japanese Patent Application Publication No. 2012-255994

### SUMMARY

In the image formation apparatus the image formation units, amounts of consumption of the toners usually vary among the image formation units depending on the contents of formed images. Meanwhile, in each image formation unit, a deteriorated toner is more likely to be generated in the case of repeating image formation with small toner consumption amounts. Accordingly, in the image formation apparatus including the image formation units each provided with its own waste toner collection container, the image formation units potentially have different remaining capacities in the waste toner collection containers.

On the other hand, each image formation unit is replaced either when the photosensitive drum as an expendable part reaches end of its product life out or when the waste toner collection container is full. In other words, the image formation unit needs to be replaced when the waste toner collection container is full even if its expendable part still has the remaining product life. In particular, an image formation unit that generates a larger amount of the deteriorated toner than the other image formation units do has a shorter period before its waste toner collection container gets full. Accordingly, this image formation unit is bound to be replaced earlier than the other image formation units even though its expendable part still has the remaining product life.

As described above, an image formation apparatus has a problem that a usable period of an image formation unit therein may be reduced because time for replacement comes too early along with collection of the waste toner in the waste toner collection container.

An object of an aspect of one or more embodiments is to provide an image formation apparatus and a method of determining a developer collection destination, which are capable of extending a usable period of replacement units.

An image formation apparatus according to an aspect of one or more embodiments may include: replacement units, each being replaceable and including an expendable part and a developer collection container; and a determination unit. The determination unit is configured to: acquires an expendable part life progress degree representing a degree of progress in used amount of the expendable part relative to a product life of the expendable part and a collection container capacity progress degree representing a degree of progress in used amount of the developer collection container relative to a capacity of the developer collection container for each of the replacement units; and determines a developer collection container as a developer collection destination out of the developer collection containers of the replacement units, based on the acquired expendable part life degrees and the acquired collection container capacity progress degrees.

According to the aspect, the developer collection destination can be defined as the developer collection container of one of the replacement units, which has the degree of progress in used amount of the developer collection container relative to the capacity thereof being smaller than the degree of progress in used amount of the expendable part relative to the product life thereof, that is, the developer collection container having a larger remaining capacity relative to the remaining product life of the expandable part. This may enable the waste toner collection containers in the replacement units to collect the developers as evenly as possible.

Accordingly, it may be possible to implement an image formation apparatus and a method of determining a developer collection destination, which are capable of extending a usable period of the units subject to replacement.

### BRIEF DESCRIPTION OF DRAWINGS

FIG. 1 is a diagram illustrating a side view of a configuration of a principal part of an image formation apparatus;

FIG. 2 is a diagram illustrating an enlarged side view of a configuration of an image formation unit;

FIG. 3 is a block diagram illustrating a view of a functional configuration of the image formation apparatus;

FIG. 4 is a diagram illustrating a development view of a surface of a photosensitive drum in a state where a deteriorated toner adheres to a deteriorated toner disposal pattern;

FIG. 5 is a flowchart illustrating an operation at a start of printing;

FIG. 6 is a flowchart illustrating procedures of deteriorated toner disposal processing; and

FIG. 7 is a table representing an example of a state of the image formation apparatus at a certain point of time by using numerical values.

### DETAILED DESCRIPTION

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only. One or more embodiments are explained in detail below with reference to the drawings.

### 1. CONFIGURATION OF PRINCIPAL PART OF IMAGE FORMATION APPARATUS

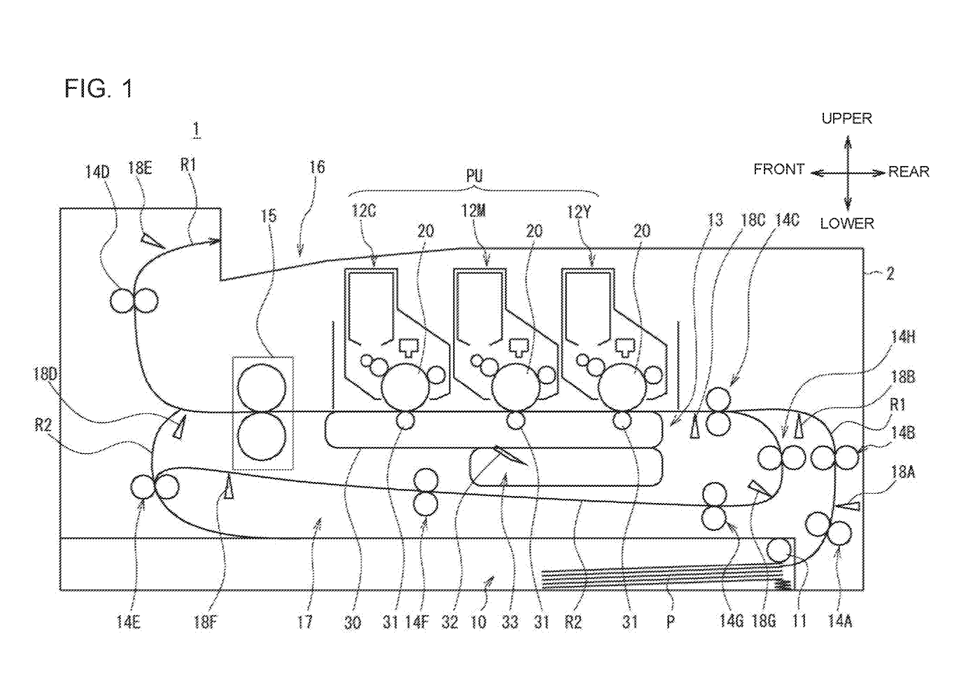

FIG. 1 illustrates a configuration of a principal part of an image formation apparatus 1. The image formation apparatus 1 is an electrophotographic color printer which prints (forms) an image on a medium P such as a sheet of paper based on print data received from a host device such as a not-illustrated personal computer (PC). The image formation apparatus 1 includes a substantially box-shaped apparatus housing 2. Here, the left side of the apparatus housing 2 in FIG. 1 is defined as a front face while the right side thereof in FIG. 1 is defined as a rear face. Hence, a direction from the front face to the rear face of the apparatus housing 2 is defined as a rearward direction, a direction from the rear face to the front face thereof is defined as a forward direction, a direction from a lower side to an upper side of the apparatus housing 2 is defined as an upward direction, a direction from the upper side to the lower side of the apparatus housing 2 is defined as a downward direction, a direction from a front side to a back side of the apparatus housing 2 in FIG. 1 is defined as a rightward direction, and a direction from the back side to the front side of the apparatus housing 2 in FIG. 1 is defined as a leftward direction.

In the apparatus housing 2, components are arranged along a conveyance path R1 for the medium P. Specifically, a media storage tray 10 to stack such media P is provided in an attachable and detachable manner to a lower part in the apparatus housing 2. Moreover, a pick-up roller 11 is provided on a rear end side of the media storage tray 10 in the apparatus housing 2. The pick-up roller 11 picks up and sends out the media P stacked on the media storage tray 10 sequentially from the top to the conveyance path R1 that is connected to a rear end portion of the media storage tray 10.

Moreover, three image formation units 12C, 12M, and 12Y that correspond to developers of multiple colors (such as toners of three colors of cyan (C), magenta (M), and yellow (Y)) to be handled by the image formation apparatus 1 are arranged at an upper part in the apparatus housing 2 and in a front-back direction along the conveyance path R1.

Note that in the image formation apparatus 1, the three image formation units 12 (12C, 12M, and 12Y) are integrated into a single integrated image formation unit PU, and the integrated image formation unit PU is provided in an attachable and detachable manner to the apparatus housing 2.

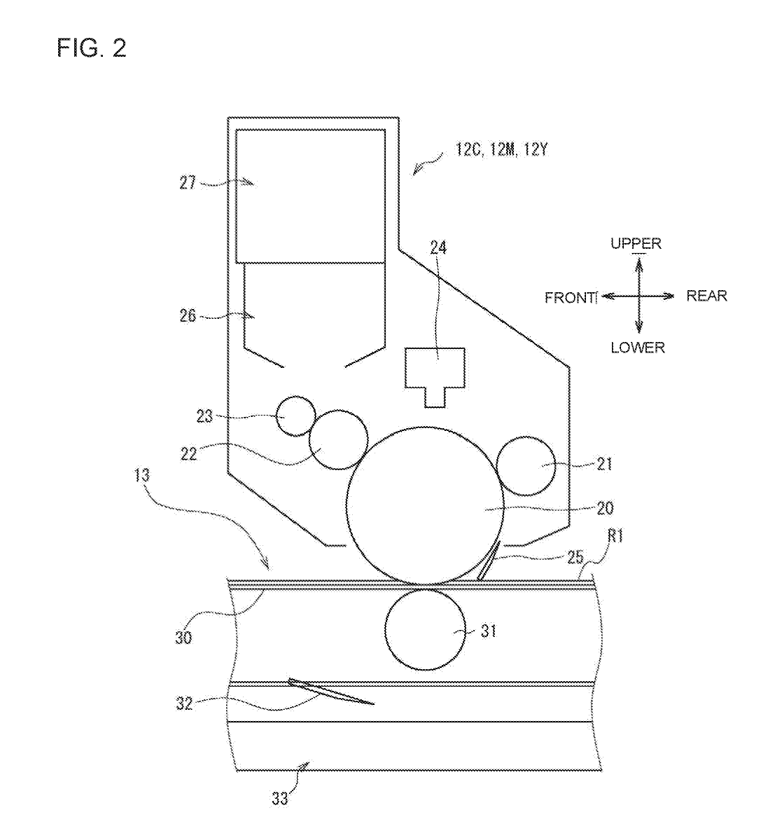

As illustrated in an enlarged view of FIG. 2 in addition to FIG. 1, the three image formation units 12 (12C, 12M, and 12Y) have the same configuration and each unit includes a photosensitive drum 20 serving as an image carrier, a charge roller 21 serving as a charging member, a development roller 22 serving as a developer carrier, a supply roller 23 serving as a developer supply member, an LED head 24 serving as an exposure device, a cleaning blade 25, a toner cartridge 26, and a drum waste toner collection container 27.

The LED head 24 is a device which is arranged above and opposed to the photosensitive drum 20, and forms an electrostatic latent image on a surface of the photosensitive drum 20 by conducting exposure while irradiating the surface of the photosensitive drum 20 with light based on image data included in print data received from the host device.

The charge roller 21 is a component which is provided in such a way as to come into pressure contact with the surface of the photosensitive drum 20, and charges the surface of the photosensitive drum 20 uniformly and homogeneously. The development roller 22 is a component which is provided in such a way as to come into pressure contact with the surface of the photosensitive drum 20, and forms a toner image by attaching the toner to the electrostatic latent image formed on the surface of the photosensitive drum 20.

The supply roller 23 is a component which is provided in such a way as to come into pressure contact with the surface of the photosensitive drum 20, and supplies the toner that is fed from the toner cartridge 26 to the development roller 22. The cleaning blade 25 is a component which is provided in such a way as to come into pressure contact with the surface of the photosensitive drum 20, and removes the toner adhering to the photosensitive drum 20. The drum waste toner collection container 27 is a container to collect the waste toner removed from the photosensitive drum 20 by using the cleaning blade 25. Although illustration is omitted, each of the three image formation units 12 (12C, 12M, and 12Y) also includes a conveyance unit which conveys the waste toner removed by using the cleaning blade 25 to the drum waste toner collection container 27.

The integrated image formation unit PU is a unit subject to replacement (a replacement unit), which is supposed to be replaced with a new one either when the photosensitive drum 20 of any one of the three image formation units 12 (12C, 12M, and 12Y) reaches end of its product life or when the drum waste toner collection container 27 of any one of the three image formation units 12 (12C, 12M, and 12Y) is full.

Moreover, a transfer unit 13 is provided immediately below the integrated image formation unit PU in the apparatus housing 2. The transfer unit 13 is provided in an attachable and detachable manner to the apparatus housing 2, and includes a transfer belt 30, three transfer rollers 31 serving as transfer members, a belt cleaning blade 32, and a belt waste toner collection container 33 as illustrated in FIG. 2 in addition to FIG. 1.

The transfer belt 30 is a component which is provided in such a way as to be freely travelable along the conveyance path R1, and conveys the medium P along the conveyance path R1. The three transfer rollers 31 are arranged below and opposed to the three photosensitive drums 20 while sandwiching the transfer belt 30 in between, respectively. Each transfer roller 31 is a component which transfers the toner image formed on the photosensitive drum 20 to the medium P being conveyed by the transfer belt 30 as the medium P is passed between the transfer roller 31 and the photosensitive drum 20, by charging the medium P in a reverse polarity to that of the toner.

The belt cleaning blade 32 is a component which is provided in such a way as to come into pressure contact with the transfer belt 30, and removes the toners adhering to the transfer belt 30. The belt waste toner collection container 33 is a container to collect the waste toners removed from the transfer belt 30 by using the belt cleaning blade 32. The transfer unit 13 is a unit subject to replacement (a replacement unit), which is supposed be replaced with a new one either when the transfer belt 30 reaches end of its product life or when the belt waste toner collection container 33 is full.

Back to FIG. 1, paired conveyance rollers 14A to 14C are provided on a section of the conveyance path R1 from the media storage tray 10 to the transfer belt 30 in the apparatus housing 2 in such a way that the rollers that form each pair are opposed to each another while sandwiching the conveyance path R1 in between. The conveyance rollers 14A to 14C are configured to convey the medium P picked up and sent out from the media storage tray 10 to the transfer belt 30 along the conveyance path R1.

Moreover, a fixing device 15 is provided on a downstream side in a medium conveyance direction (that is, a front side) of the transfer belt 30 in the apparatus housing 2. The fixing device 15 includes a heating roller and a back-up roller which are opposed to each other while sandwiching the conveyance path R1 in between. The fixing device 15 is configured to fix the toner images, which are transferred onto the medium P by the transfer unit 13, to the medium P by pressurizing and heating the toner images.

Furthermore, an outer part of an upper face of the apparatus housing 2 is formed into a discharge stacker 16 to which the medium P is discharged. The conveyance path R1 is connected to the discharge stacker 16. In addition, conveyance rollers 14D are provided on a section of the conveyance path R1 from the fixing device 15 to the discharge stacker 16 in the apparatus housing 2 in such a way as to be opposed to each another while sandwiching the conveyance path R1 in between. The conveyance rollers 14D are configured to convey the medium P, to which the toner images are fixed by using the fixing device 15, to the discharge stacker 16 along the conveyance path R1.

In addition, a conveyance unit 17 for duplex printing (hereinafter referred to as a duplex printing conveyance unit) is provided in the apparatus housing 2 between the transfer unit 13 as well as the fixing device 15 and the media storage tray 10. The duplex printing conveyance unit 17 includes a conveyance path R2 and paired conveyance rollers 14E to 14H provided in such a way that the rollers that form each pair are opposed to each another while sandwiching the conveyance path R2 in between.

The conveyance path R2 is connected to the conveyance path R1 at two locations, namely, on a downstream side in the medium conveyance direction of the fixing device 15 and on an upstream side in the medium conveyance direction of the transfer belt 30, and includes a reversing unit for turning back and conveying the medium P. The conveyance rollers 14E to 14H are configured to turn back the medium P having been conveyed from the conveyance path R1 to the conveyance path R2 on the downstream side in the medium conveyance direction of the fixing device 15 at the time of the duplex printing while further conveying the medium P along the conveyance path R2, and then to put the medium P back to the conveyance path R1 on the upstream side in the medium conveyance direction of the transfer belt 30.

Moreover, medium detection sensors 18A to 18G to detect positions of the medium P are provided at multiple positions on the conveyance paths R1 and R2 in the apparatus housing 2. The overall configuration of the image formation apparatus 1 is as described above.

Now, a printing operation in a case of one-side printing by the image formation apparatus 1 is briefly explained. When the image formation apparatus 1 starts the printing operation, the media P stacked on the media storage tray 10 are separated off into individual sheets and then picked up and sent out by the pick-up roller 11 to the conveyance path R1. Each medium P picked up and sent out to the conveyance path R1 is conveyed to the transfer unit 13, and the transfer belt 30 of the transfer unit 13 further conveys the medium P to the image formation units 12Y, 12M, and 12C in this order.

Here, each of the image formation units 12Y, 12M, and 12C forms the electrostatic latent image on the surface of the photosensitive drum 20 by charging the surface of the photosensitive drum 20 with the charge roller 21 and conducting the exposure with the LED head 24. Moreover, each of the image formation units 12Y, 12M, and 12C forms the toner image on the surface of the photosensitive drum 20 by electrostatically attaching a thin layer of the toner provided on the development roller 22 to the electrostatic latent image formed on the surface of the photosensitive drum 20.

The transfer rollers 31 transfer the toner images thus formed on the surfaces of the respective photosensitive drums 20 onto the medium P being conveyed by the transfer belt 30. In this way, the toner images are formed on the medium P.

The medium P provided with the toner images by the image formation units 12Y, 12M, and 12C is conveyed from the transfer unit 13 to the fixing device 15. The fixing device 15 fixes the toner images to the medium P by pressuring and heating the medium P. Thus, the image is formed (that is, printed) on the medium P. Thereafter, the medium P is conveyed to the discharge stacker 16 and discharged onto the discharge stacker 16. The printing operation of the image formation apparatus 1 is as described above.

### 2. FUNCTIONAL CONFIGURATION OF IMAGE FORMATION APPARATUS

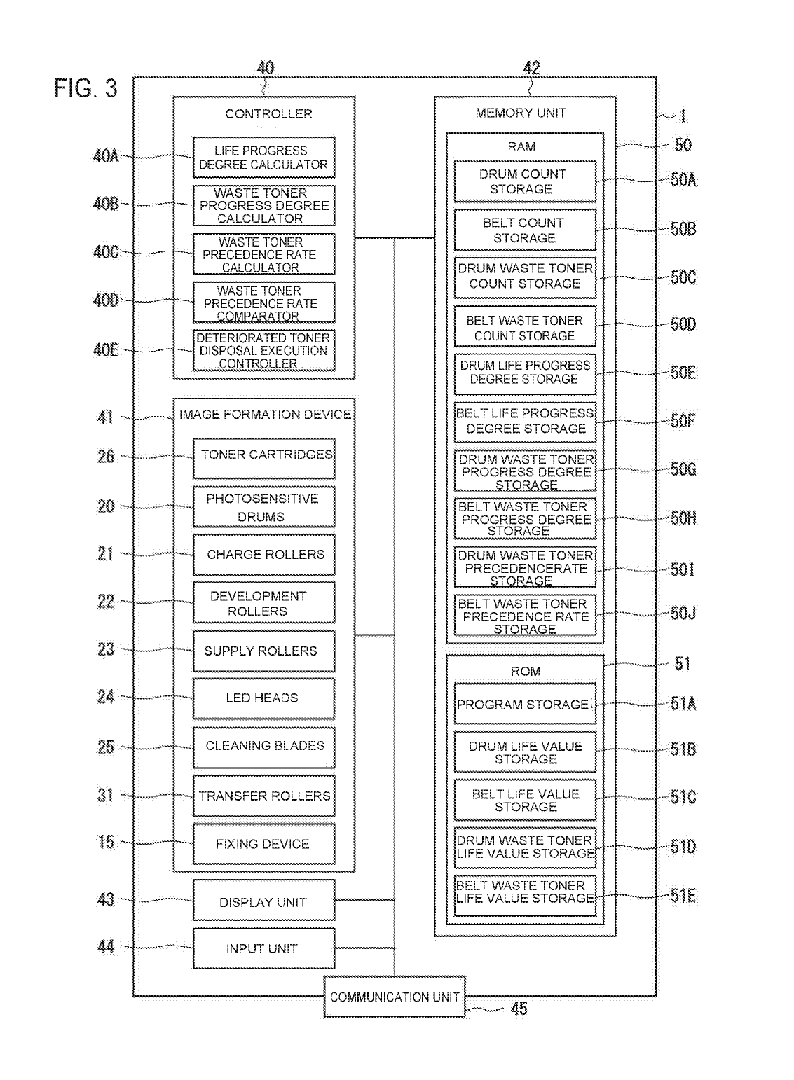

Next, a description is given of a functional configuration of the image formation apparatus 1. FIG. 3 illustrates the functional configuration of the image formation apparatus 1. As the functional configuration, the image formation apparatus 1 includes a controller 40, an image formation device 41, a memory unit 42 or a storage unit, a display unit 43, an input unit 44, and a communication unit 45.

The image formation device 41 is a device having a function to form the image, including: the toner cartridges 26, the photosensitive drums 20, the charge rollers 21, the development rollers 22, the supply rollers 23, the LED heads 24, and the cleaning blades 25, which are provided to the image formation units 12 (12C, 12M, and 12Y); the transfer rollers 31 provided to the transfer unit 13; and the fixing device 15.

The memory unit 42 is a unit having a function to memorize a variety of information, which includes a random access memory (RAM) 50 and a read only memory (ROM) 51. The RAM 50 is a non-volatile memory, for instance, which functions as a drum count storage 50A, a belt count storage 50B, a drum waste toner count storage 50C, a belt waste toner count storage 50D, a drum life progress degree storage 50E, a belt life progress degree storage 50F, a drum waste toner progress degree storage 50G, a belt waste toner progress degree storage 50H, a drum waste toner precedence rate storage 50I, and a belt waste toner precedence rate storage 50J. In the meantime, the ROM 51 functions as a program storage 51A, a drum life value storage 51B, a belt life value storage 51C, a drum waste toner life value storage 51D, and a belt waste toner life value storage 51E.

The drum count storage 50A of the RAM 50 memorizes a drum count, which is a value representing the number of times of use of the photosensitive drum 20, for each of the photosensitive drums 20 provided to the image formation units 12 (12C, 12M, and 12Y). Specifically, the drum count is based on a reference rotation amount defined as one-third of a rotation amount of the photosensitive drum 20 in the case of continuously printing three A4 media P, for example. The controller 40 increments the drum count by +1 every time the photosensitive drum 20 is rotated by the reference rotation amount. The belt count storage 50B memorizes a belt count which is a value representing the number of times of use of the transfer belt 30. Specifically, the controller 40 increments the belt count by +1 every time one medium P is printed, for example.

The drum waste toner count storage 50C memorizes a drum waste toner count, which is a value representing an amount of the waste toner collected in the drum waste toner collection container 27 (that is, the toner removed from the photosensitive drum 20 by using the cleaning blade 25), for each of the photosensitive drums 20 provided to the image formation units 12 (12C, 12M, and 12Y). Specifically, the drum waste toner count is expressed in units of dot counts. A dot count is a value obtained by converting an amount of a toner into a value in units of dots representing a unit of exposure with the LED head 24. The drum waste toner count is calculated by the controller 40 in accordance with a predetermined calculation method to be described later.

The belt waste toner count storage 50D memorizes a belt waste toner count, which is a value representing an amount of the waste toners collected into the belt waste toner collection container 33 (that is, the toners removed from the transfer belt 30 by using the belt cleaning blade 32). Specifically, the belt waste toner count is expressed in units of dot counts as with the drum waste toner count. The belt waste toner count is also calculated by the controller 40 in accordance with a predetermined calculation method to be described later.

The drum life progress degree storage 50E stores a drum life progress degree, which is a value representing a used amount of the photosensitive drum 20 as the expendable part relative to the product life thereof, for each of the photosensitive drums 20 provided to the image formation units 12 (12C, 12M, and 12Y). Specifically, the drum life progress degree is expressed as a current wear rate of the photosensitive drum 20. In other words, the case of the drum life progress degree reaching 100% means the product life of the photosensitive drum 20 reaching its end. The belt life progress degree storage 50F stores a belt life progress degree, which is a value representing a used amount of the transfer belt 30 as the expendable part relative to the product life thereof. Specifically, the belt life progress degree is expressed as a current wear rate of the transfer belt 30. In other words, the case of the belt life progress degree reaching 100% means the product life of the transfer belt 30 reaching its end.

The drum waste toner progress degree storage 50G stores a drum waste toner progress degree, which is a value representing a degree of progress in used amount of the drum waste toner collection container 27 relative to its capacity, for each of the drum waste toner collection containers 27 provided to the image formation units 12 (12C, 12M, and 12Y). Specifically, the drum waste toner progress degree is expressed as a current usage rate of the drum waste toner collection container 27. In other words, the case of the drum waste toner progress degree reaching 100% means that the drum waste toner collection container 27 is filled with the waste toner. The belt waste toner progress degree storage 50H stores a belt waste toner progress degree, which is a value representing a degree of progress of a used amount of the belt waste toner collection container 33 relative to its capacity. Specifically, the belt waste toner progress degree is expressed as a current usage rate of the belt waste toner collection container 33. In other words, the case of the belt waste toner progress degree reaching 100% means that the belt waste toner collection container 33 is filled with the waste toners.

The drum waste toner precedence rate storage 50I stores a drum waste toner precedence rate, which is a value representing how much the drum waste toner progress degree precedes the drum life progress degree. The belt waste toner precedence rate storage 50J stores a belt waste toner precedence rate, which is a value representing how much the belt waste toner progress degree precedes the belt life progress degree.

Meanwhile, the program storage 51A of the ROM 51 stores various programs to be executed by the controller 40. The drum life value storage 51B memorizes a drum life value representing the product life of each photosensitive drum 20. Specifically, the drum life value is expressed in units of drum counts. The belt life value storage 51C memorizes a belt life value representing the product life of the transfer belt 30. Specifically, the belt life value is expressed in units of belt counts. The drum waste toner life value storage 51D stores a drum waste toner life value which is a value representing the capacity of each drum waste toner collection container 27. Specifically, the drum waste toner life value is expressed in units of dot counts. The belt waste toner life value storage 51E stores a belt waste toner life value which is a value representing the capacity of the belt waste toner collection container 33. Specifically, the belt waste toner life value is expressed in units of dot counts.

The controller 40 is a part having a function to control respective units in the image formation apparatus 1, and functions as a life progress degree calculator 40A, a waste toner progress degree calculator 40B, a waste toner precedence rate calculator 40C, a waste toner precedence rate comparator 40D, and a deteriorated toner disposal execution controller 40E. For example, the controller 40 can be implemented using: a memory as a storage device that stores a control program; and a processor that executes the control program stored in the memory. Otherwise, parts of the controller 40 may be implemented using a circuit and the rest of the controller 40 may be implemented using: a memory as a storage device that stores a control program; and a processor that executes the control program stored in the memory.

The life progress degree calculator 40A calculates the drum life progress degree and the belt life progress degree mentioned above. The waste toner progress degree calculator 40B calculates the drum waste toner progress degree and the belt waste toner progress degree mentioned above. The waste toner precedence rate calculator 40C calculates the drum waste toner precedence rate and the belt waste toner precedence rate mentioned above. The waste toner precedence rate comparator 40D compares the drum waste toner precedence rate with the belt waste toner precedence rate, and determines either the drum waste toner collection container 27 or the belt waste toner collection container 33 as a destination of collection of the waste toner based on a result of the comparison.

The deteriorated toner disposal execution controller 40E executes deteriorated toner disposal processing by controlling the image formation device 41. The deteriorated toner disposal processing is processing that takes place before a start of printing on the medium P, and is configured to cause the deteriorated toners generated in the image formation units 12 (12C, 12M, and 12Y) to be ejected onto the photosensitive drums 20 of the image formation units 12 (12C, 12M, and 12Y) and then to collect the deteriorated toners into the drum waste toner collection containers 27 or the belt waste toner collection container 33.

In the case of collecting the deteriorated toner generated in the image formation unit 12Y into the drum waste toner collection container 27 of the image formation unit 12Y, for example, the deteriorated toner disposal execution controller 40E causes the deteriorated toner generated in the image formation unit 12Y to be ejected onto its photosensitive drum 20. Then, this toner is not transferred to the transfer belt 30 but is removed by using the cleaning blade 25 instead. The deteriorated toner (the waste toner) thus removed is collected into the drum waste toner collection container 27. The same processing takes place in the case of collecting the deteriorated toners generated in the image formation units 12M and 12C into the drum waste toner collection containers 27 of the image formation units 12M and 12C, respectively.

On the other hand, in the case of collecting the deteriorated toner generated in the image formation unit 12Y into the belt waste toner collection container 33 of the transfer unit 13, for example, the deteriorated toner disposal execution controller 40E causes the deteriorated toner generated in the image formation unit 12Y to be ejected onto its photosensitive drum 20 and then transfers the deteriorated toner to the transfer belt 30. Then, this toner is removed by using the belt cleaning blade 32. The deteriorated toner (the waste toner) thus removed is collected into the belt waste toner collection container 33. The same processing takes place in the case of collecting the deteriorated toners generated in the image formation units 12M and 12C into the belt waste toner collection container 33.

Here, the deteriorated toner disposal execution controller 40E is configured to switch whether or not the deteriorated toner ejected onto the photosensitive drum 20 is to be transferred to the transfer belt 30 by controlling a voltage applied to each transfer roller 31.

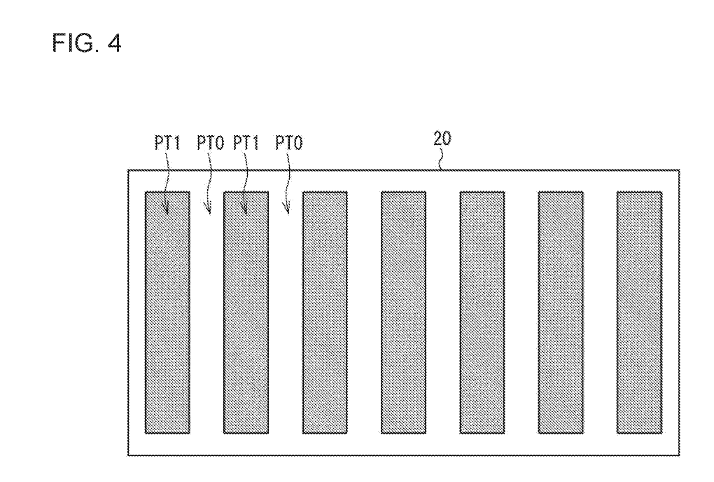

Meanwhile, at the time of execution of the deteriorated toner disposal processing, the deteriorated toner disposal execution controller 40E is configured to instruct the LED head 24 to form a pattern of an electrostatic latent image used for the disposal of the deteriorated toner (hereinafter referred to as a deteriorated toner disposal pattern) on the photosensitive drum 20, so as to cause the deteriorated toner to be ejected onto the photosensitive drum 20 by allowing the deteriorated toner to adhere to the deteriorated toner disposal pattern formed on the photosensitive drum 20. FIG. 4 illustrates an example of the deteriorated toner disposal pattern. FIG. 4 is a development diagram of the surface of the photosensitive drum 20 in a state where the deteriorated toner adheres to the deteriorated toner disposal pattern. As illustrated in FIG. 4, the deteriorated toner disposal pattern is formed into an electrostatic latent image pattern which alternates portions PT1 to which the toner adheres at a density of 50% and portions PT0 to which no toner adheres.

Back to FIG. 3, the display unit 43 is a part having a function to display a variety of information, which includes a liquid crystal panel, for example, to display a status of the image formation apparatus 1 and the like. The input unit 44 is a part having a function to accept operations from a user, which includes a touch panel and operation buttons, for example. The display unit 43 and the input unit 44 are provided on an upper part of the front face of the apparatus housing 2, for instance. The communication unit 45 is a part having a function to communicate with the host device, which includes a USB or LAN interface, for instance. The functional configuration of the image formation apparatus 1 is as described above.

Now, a description is given of methods of calculating the drum waste toner count representing the amount of the waste toner collected in each drum waste toner collection container 27 and the belt waste toner count representing the amount of the waste toner collected in the belt waste toner collection container 33.

Each of the image formation units 12C, 12M, and 12Y is configured to collect the toner removed from the photosensitive drum 20 by using the cleaning blade 25 at the time of the printing (that is, a remaining toner) and the toner removed from the photosensitive drum 20 by using the cleaning blade 25 at the time of the deteriorated toner disposal processing (that is, the deteriorated toner) into the drum waste toner collection container 27.

Here, the amount of the toner removed from the photosensitive drum 20 by using the cleaning blade 25 at the time of the printing is calculated as a value obtained by multiplying the dot count of the image data included in the print data (that is, the amount of the toner adhering to the photosensitive drum 20) by a prescribed coefficient that represents a ratio of the amount of the toner remaining on the photosensitive drum 20 without being transferred to the medium P. In other words, at the time of the printing, the controller 40 adds the value obtained by multiplying the dot count of the image data included in the print data by the prescribed coefficient to the drum waste toner count memorized in the drum waste toner count storage 50C.

Likewise, the amount of the toner removed from the photosensitive drum 20 by using the cleaning blade 25 at the time of the deteriorated toner disposal processing to collect the deteriorated toner into the belt waste toner collection container 33 is calculated as a value obtained by multiplying a dot count of the deteriorated toner disposal pattern by a prescribed coefficient that represents a ratio of the amount of the toner remaining on the photosensitive drum 20 without being transferred to the transfer belt 30. In other words, at the time of the deteriorated toner disposal processing to collect the deteriorated toner into the belt waste toner collection container 33, the controller 40 adds the value obtained by multiplying the dot count of the deteriorated toner disposal pattern by the prescribed coefficient to the drum waste toner count memorized in the drum waste toner count storage 50C.

Moreover, the amount of the toner removed from the photosensitive drum 20 by using the cleaning blade 25 at the time of the deteriorated toner disposal processing to collect the deteriorated toner into the drum waste toner collection container 27 is equivalent to the dot count of the deteriorated toner disposal pattern. In other words, at the time of the deteriorated toner disposal processing to collect the deteriorated toner into the drum waste toner collection container 27, the controller 40 adds the dot count of the deteriorated toner disposal pattern to the drum waste toner count memorized in the drum waste toner count storage 50C.

As described above, the controller 40 is configured to calculate the dot counts that represent the amounts of the waste toner to be removed from each photosensitive drum 20 by using the cleaning blade 25 at the time of the printing and at the time of the deteriorated toner disposal processing, and to add the dot counts to the drum waste toner count memorized in the drum waste toner count storage 50C. Thus, the drum waste toner count representing the amount of the waste toner collected in the drum waste toner collection container 27 is memorized in the drum waste toner count storage 50C.

In the meantime, the transfer unit 13 is configured to collect the toners, which are removed from the transfer belt 30 by using the belt cleaning blade 32 at the time of the deteriorated toner disposal processing, into the belt waste toner collection container 33.

Here, the amount of the toners to be removed from the transfer belt 30 by using the belt cleaning blade 32 at the time of the deteriorated toner disposal processing is calculated by multiplying the dot count of the deteriorated toner disposal pattern (that is, the amounts of the toners adhering to the photosensitive drums 20) by a prescribed coefficient that represents a ratio of the amount of the toners transferred to the transfer belt 30. In other words, at the time of the deteriorated toner disposal processing, the controller 40 adds the value obtained by multiplying the dot count of the deteriorated toner disposal pattern by the prescribed coefficient to the belt waste toner count memorized in the belt waste toner count storage 50D.

As described above, the controller 40 is configured to calculate the dot count representing the amount of the toners to be removed from the transfer belt 30 by using the belt cleaning blade 32 and to add the dot count to the belt waste toner count memorized in the belt waste toner count storage 50D at the time of the deteriorated toner disposal processing. In this way, the belt waste toner count representing the amount of the waste toners collected into the belt waste toner collection container 33 is memorized in the belt waste toner count storage 50D.

Here, the above-described methods of calculating the drum waste toner count and calculating the belt waste toner count are mere examples, and the drum waste toner count and the belt waste toner count may be calculated in accordance with other methods (such as known methods). For example, the drum waste toner count and the belt waste toner count may be calculated more accurately by using more pieces of information and more complicated calculation formulae.

### 3. OPERATION AT START OF PRINTING

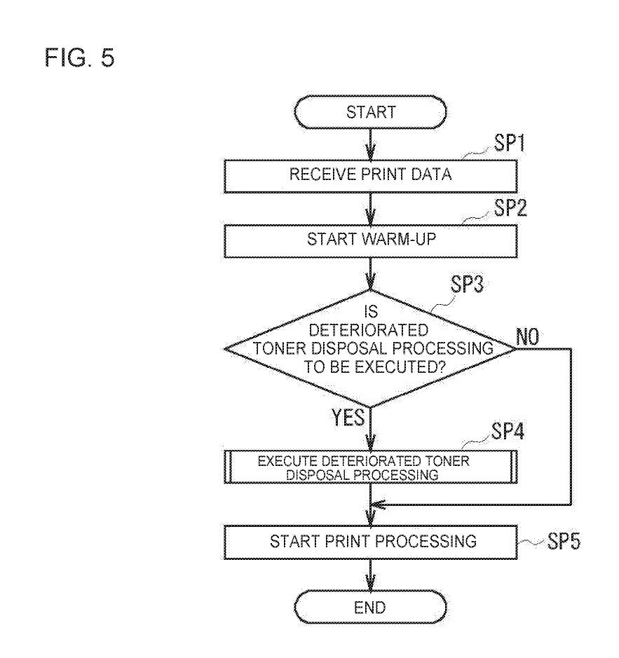

Next, an operation at the start of printing by the image formation apparatus 1 is described in detail by using a flowchart illustrated in FIG. 5. Note that the operation at the start of printing is implemented by the controller 40 that conducts an operation in accordance with a program read out of the program storage 51A.

When the controller 40 receives the print data from the host device through the communication unit 45 in step SP1, the controller 40 instructs the image formation device 41 to start warm-up before the start of printing in the subsequent step SP2. Note that the warm-up is an action to cause the image formation device 41 to prepare for the printing, and the warm-up includes a start of rotation of the photosensitive drums 20, voltage application to the charge rollers 21, the supply rollers 23, and the transfer rollers 31, heating of the fixing device 15, and the like.

In the subsequent step SP3, the deteriorated toner disposal execution controller 40E of the controller 40 determines whether or not it is appropriate to execute the deteriorated toner disposal processing for each of the image formation units 12 (12C, 12M, and 12Y). Here, the determination as to whether or not it is appropriate to execute the deteriorated toner disposal processing is conducted based on the amount of the deteriorated toner generated in each of the image formation units 12 (12C, 12M, and 12Y). In each of the image formation units 12 (12C, 12M, and 12Y), the deteriorated toner is more likely to be generated in the case of repeating image formation with a small toner consumption amount, or in other words, image formation at a low print duty. The print duty is also called a print ratio, and represents a ratio of the number of dots actually printed relative to the number of dots necessary for filling in an entire printable area of the medium P. For example, the print duty is 100% in the case of printing so as to fill in the entire printable area of the medium P, and the print duty is 0% when the printable area of the medium P is not printed at all. In each of the image formation units 12 (12C, 12M, and 12Y), the deteriorated toner is more likely to be generated in the case of repeating the printing at a print duty equal to or below 1% (which is referred to as low-duty printing), for instance.

Given the circumstances, the deteriorated toner disposal execution controller 40E is configured to estimate the amount of the deteriorated toner to be generated when the low-duty printing takes place for each of the image formation units 12 (12C, 12M, and 12Y), and to determine any of the image formation units 12 having a sum total of the deteriorated toner equal to or above a predetermined amount as a target for execution of the deteriorated toner disposal processing (that is, a target for collection of the deteriorated toner).

Specifically, the deteriorated toner disposal execution controller 40E calculates the print duty for each of the image formation units 12 (12C, 12M, and 12Y) based on the size of the medium P and on the print data at the time of printing. Then, the deteriorated toner disposal execution controller 40E determines any of the image formation units 12 having the calculated print duty equal to or below 1% as the image formation unit 12 having lately conducted the low-duty printing. Moreover, the deteriorated toner disposal execution controller 40E calculates a value of the dot count related to the latest low-duty printing based on a value of the dot count (that is, the amount of the toner transferred to the medium P) in the case of conducting the printing at the print duty of 1%. Note that the values of the dot count in the case of conducting the printing at the print duty of 1% are prepared depending on the sizes of the media P and are memorized in the ROM 51 in advance.

Here, if the dot count in the case of printing on the A4-size medium P at the print duty of 1% is 100 and a duty ratio of the latest low-duty printing conducted on the A4-size medium P is 0.6%, for example, then the dot count of the latest low-duty printing is calculated as 100×0.6=60. Moreover, the deteriorated toner disposal execution controller 40E obtains a value by subtracting the dot count of the latest low-duty printing (such as 60) from the dot count in the case of printing on the A4-size medium P at the print duty of 1% (such as 100), and determines the obtained value (such as 40) as the amount of the toner not consumed in the latest low-duty printing and remaining in the image formation unit 12, that is, as the amount of the deteriorated toner generated in the latest printing.

As described above, the deteriorated toner disposal execution controller 40E calculates the amount of the deteriorated toner generated in the latest printing for each of the image formation units 12 (12C, 12M, and 12Y). Then, the deteriorated toner disposal execution controller 40E adds the amount of the deteriorated toner generated in the latest printing to the amount of the deteriorated toner generated in the past printing already memorized in the RAM 50 for each of the image formation units 12 (12C, 12M, and 12Y). In this way, the RAM 50 memorizes the sum total of the deteriorated toner for each of the image formation units 12 (12C, 12M, and 12Y).

The deteriorated toner disposal execution controller 40E reads the sum total of the deteriorated toner for each of the image formation units 12 (12C, 12M, and 12Y) out of the RAM 50, and determines any of the image formation units 12 having the sum total of the deteriorated toner equal to or above a predetermined amount as the target for execution of the deteriorated toner disposal processing.

The description is given herein of the method of estimating the amount of the deteriorated toner based on the print duty and the dot count as an example. However, without limitation to the foregoing, the amount of the deteriorated toner may be estimated in accordance with other methods (such as known methods). In the meantime, any one of the image formation units 12 (12C, 12M, and 12Y) having the sum total of the deteriorated toner equal to or above the predetermined amount is determined herein as the target for execution of the deteriorated toner disposal processing. However, without limitation to the foregoing, the target for execution of the deteriorated toner disposal processing may be determined in accordance with other methods. For example, any of the image formation units 12 having conducted the low-duty printing in the previous printing may be determined as the target for execution of the deteriorated toner disposal processing, or any of the image formation units 12 having repeated the low-duty printing for a predetermined number of sheets may be determined as the target for execution of the deteriorated toner disposal processing.

When there is no image formation unit 12 determined as the target for execution of the deteriorated toner disposal processing, the controller 40 obtains a negative result in the above-described step SP3 and then proceeds to step SP5 to start print processing on the medium P while controlling the image formation device 41.

On the other hand, when there is at least one image formation unit 12 determined as the target for execution of the deteriorated toner disposal processing, the controller 40 obtains an affirmative result in the above-described step SP3 and then proceeds to step SP4 to execute the deteriorated toner disposal processing. Procedures of the deteriorated toner disposal processing are described later. After the execution of the deteriorated toner disposal processing, the controller 40 proceeds to step SP5 to start the print processing on the medium P while controlling the image formation device 41. The operation at the start of printing by the image formation apparatus 1 is as described above.

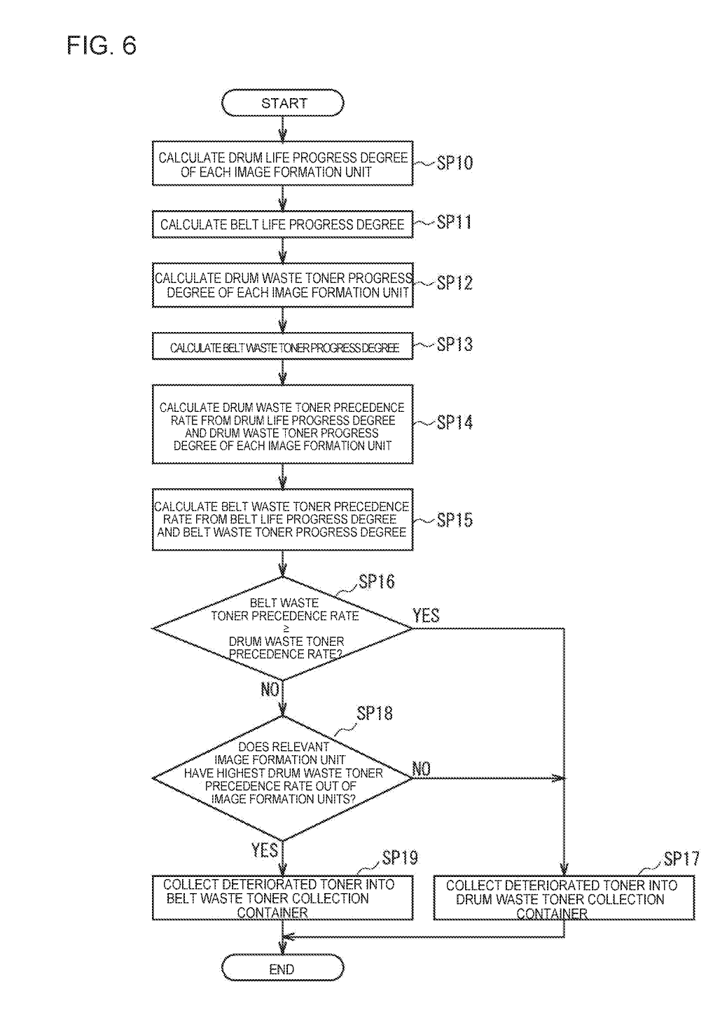

Now, the procedures of the deteriorated toner disposal processing to be conducted in step SP4 are described in detail with reference to a flowchart illustrated in FIG. 6. In step SP10 in the first place, the life progress degree calculator 40A calculates the drum life progress degree for each of the photosensitive drums 20 included in the image formation units 12 (12C, 12M, and 12Y). Specifically, the life progress degree calculator 40A calculates each drum life progress degree by using the drum count memorized in the drum count storage 50A and the drum life value memorized in the drum life value storage 51B. To be more precise, the life progress degree calculator 40A defines a value obtained by dividing the drum count by the drum life value (in units of percent) as the drum life progress degree. The life progress degree calculator 40A causes the drum life progress degree storage 50E to memorize the drum life progress degree thus calculated for each of the photosensitive drums 20 included in the image formation units 12 (12C, 12M, and 12Y).

In the subsequent step SP11, the life progress degree calculator 40A calculates the belt life progress degree. Specifically, the life progress degree calculator 40A calculates the belt life progress degree by using the belt count memorized in the belt count storage 50B and the belt life value memorized in the belt life value storage 51C. To be more precise, the life progress degree calculator 40A defines a value obtained by dividing the belt count by the belt life value (in units of percent) as the belt life progress degree. The life progress degree calculator 40A causes the belt life progress degree storage 50F to memorize the belt life progress degree thus calculated.

In the subsequent step SP12, the waste toner progress degree calculator 40B calculates the drum waste toner progress degree for each of the photosensitive drums 20 included in the image formation units 12 (12C, 12M, and 12Y). Specifically, the waste toner progress degree calculator 40B calculates each drum waste toner progress degree by using the drum waste toner count memorized in the drum waste toner count storage 50C and the drum waste toner life value memorized in the drum waste toner life value storage 51D. To be more precise, the waste toner progress degree calculator 40B defines a value obtained by dividing the drum waste toner count by the drum waste toner life value (in units of percent) as the drum waste toner progress degree. The waste toner progress degree calculator 40B causes the drum waste toner progress degree storage 50G to memorize the drum waste toner progress degree thus calculated for each of the photosensitive drums 20 included in the image formation units 12 (12C, 12M, and 12Y).

In the subsequent step SP13, the waste toner progress degree calculator 40B calculates the belt waste toner progress degree. Specifically, the waste toner progress degree calculator 40B calculates the belt waste toner progress degree by using the belt waste toner count memorized in the belt waste toner count storage 50D and the belt waste toner life value memorized in the belt waste toner life value storage 51E. To be more precise, the waste toner progress degree calculator 40B defines a value obtained by dividing the belt waste toner count by the belt waste toner life value (in units of percent) as the belt waste toner progress degree. The waste toner progress degree calculator 40B causes the belt waste toner progress degree storage 50H to memorize the belt waste toner progress degree thus calculated.

In the subsequent step SP14, the waste toner precedence rate calculator 40C calculates the drum waste toner precedence rate for each of the photosensitive drums 20 included in the image formation units 12 (12C, 12M, and 12Y). Specifically, the waste toner precedence rate calculator 40C calculates each drum waste toner precedence rate by using the drum life progress degree memorized in the drum life progress degree storage 50E and the drum waste toner progress degree memorized in the drum waste toner progress degree storage 50G. To be more precise, the waste toner precedence rate calculator 40C defines a value obtained by subtracting the drum life progress degree from the drum waste toner progress degree as the drum waste toner precedence rate. The case of the drum waste toner precedence rate being positive means that the drum waste toner progress degree precedes the drum life progress degree, or in other words, that the usage rate of the drum waste toner collection container 27 is larger than the wear rate of the photosensitive drum 20. The waste toner precedence rate calculator 40C causes the drum waste toner precedence rate storage 50I to memorize the drum waste toner precedence rate thus calculated for each of the photosensitive drums 20 included in the image formation units 12 (12C, 12M, and 12Y).

In the subsequent step SP15, the waste toner precedence rate calculator 40C calculates the belt waste toner precedence rate. Specifically, the waste toner precedence rate calculator 40C calculates the belt waste toner precedence rate by using the belt life progress degree memorized in the belt life progress degree storage 50F and the belt waste toner progress degree memorized in the belt waste toner progress degree storage 50H. To be more precise, the waste toner precedence rate calculator 40C defines a value obtained by subtracting the belt life progress degree from the belt waste toner progress degree as the belt waste toner precedence rate. The case of the belt waste toner precedence rate being positive means that the belt waste toner progress degree precedes the belt life progress degree, or in other words, that the usage rate of the belt waste toner collection container 33 is larger than the wear rate of the transfer belt 30. The waste toner precedence rate calculator 40C causes the belt waste toner precedence rate storage 50J to memorize the belt waste toner precedence rate thus calculated. The drum waste toner precedence rates of the image formation units 12C, 12M and 12Y and the belt waste toner precedence rate of the transfer unit 13 are obtained by conducting the above-described processing.

In the subsequent step SP16, the waste toner precedence rate comparator 40D compares the drum waste toner precedence rate with the belt waste toner precedence rate in terms of the image formation unit 12 being the target for execution of the deteriorated toner disposal processing so as to determine whether or not the belt waste toner precedence rate the drum waste toner precedence rate holds true, that is, whether the belt waste toner precedence rate precedes the drum waste toner precedence rate. Here, if there are two or more image formation units 12 being the targets for execution of the deteriorated toner disposal processing, then the processing in step S16 and thereafter is to be conducted while sequentially selecting one of the image formation units 12 being the targets for execution of the deteriorated toner disposal processing.

Here, the case of the belt waste toner precedence rate the drum waste toner precedence rate holding true means that the drum waste toner collection container 27 of the selected image formation unit 12 has more room for containing the waste toner than the belt waste toner collection container 33 of the transfer unit 13 does. In this case, the waste toner precedence rate comparator 40D obtains an affirmative result in step SP16 and then proceeds to step SP17. In step SP17, the deteriorated toner disposal execution controller 40E determines the drum waste toner collection container 27 as a destination of collection of the deteriorated toner generated in the selected image formation unit 12. Then, the deteriorated toner disposal execution controller 40E causes the deteriorated toner generated in the selected image formation unit 12 to be ejected onto the photosensitive drum 20 so as to remove the deteriorated toner therefrom by using the cleaning blade 25, thus collecting the deteriorated toner into the drum waste toner collection container 27.

On the other hand, the case of the drum waste toner precedence rate>the belt waste toner precedence rate holding true means that the belt waste toner collection container 33 of the transfer unit 13 has more room for containing the waste toner than the drum waste toner collection container 27 of the selected image formation unit 12 does. In this case, the waste toner precedence rate comparator 40D obtains a negative result in step SP16 and then proceeds to step SP18.

In step SP18, the waste toner precedence rate comparator 40D determines whether or not the drum waste toner precedence rate of the selected image formation unit 12 is the largest of (precedes those of) all of the image formation units 12. Here, when the waste toner precedence rate comparator 40D determines that the drum waste toner precedence rate of the selected image formation unit 12 precedes those of all of the image formation units 12, the controller 40 obtains an affirmative result in step SP18 and then proceeds to step SP19. In step SP19, the deteriorated toner disposal execution controller 40E determines the belt waste toner collection container 33 as the destination of collection of the deteriorated toner generated in the selected image formation unit 12. Then, the deteriorated toner disposal execution controller 40E controls the image formation device 41 in such a way as to cause the deteriorated toner generated in the selected image formation unit 12 to be ejected onto the photosensitive drum 20 and then transferred to the transfer belt 30, thus removing the deteriorated toner by using the belt cleaning blade 32 and collecting the deteriorated toner into the belt waste toner collection container 33.

On the other hand, when the waste toner precedence rate comparator 40D determines that the progress of the drum waste toner precedence rate of the selected image formation unit 12 is not the largest of those of all of the image formation units 12, the controller 40 obtains a negative result in step SP18 and then proceeds to SP17. In step SP17, the deteriorated toner disposal execution controller 40E determines the drum waste toner collection container 27 as the destination of collection of the deteriorated toner generated in the selected image formation unit 12. Then, the deteriorated toner disposal execution controller 40E controls the image formation device 41 in such a way as to cause the deteriorated toner generated in the selected image formation unit 12 to be ejected onto the photosensitive drum 20 so as to remove the deteriorated toner therefrom by using the cleaning blade 25, thus collecting the deteriorated toner into the drum waste toner collection container 27.

The controller 40 conducts the above-described processing from step SP16 to step SP19 for all of the image formation units 12 being the targets for execution of the deteriorated toner disposal processing, and then terminates the deteriorated toner disposal processing. The procedures of the deteriorated toner disposal processing to be conducted in step SP4 are as described above.

As mentioned above, the deteriorated toner disposal processing is configured such that the belt waste toner collection container 33 is determined as the destination of collection of the waste toner only for the image formation unit 12 having the largest drum waste toner precedence rate out of the image formation units 12 with the drum waste toner collection containers 27 having less room than the belt waste toner collection container 33 whereas the drum waste toner collection containers 27 of their own are determined as the destinations of collection of the waste toners for the rest of the image formation units 12.

The reason for the above-mentioned configuration is that the image formation units 12C, 12M, and 12Y constitute the integrated image formation unit PU and all of the image formation units 12C, 12M, and 12Y need to be replaced when any one of the drum waste toner collection containers 27 included in the respective image formation units 12C, 12M, and 12Y is full. In other words, by causing the belt waste toner collection container 33 to collect the waste toner only from the image formation unit 12 having the largest drum waste toner precedence rate out of the image formation units 12 with the drum waste toner collection containers 27 having less room than the belt waste toner collection container 33, it is possible to minimize further progress in drum waste toner precedence rate of the image formation unit 12 having the largest drum waste toner precedence rate, and thus to avoid a situation in which the drum waste toner precedence rate of one of the image formation units 12 is advanced significantly more than those of the remaining image formation units 12.

Here, without limitation to the foregoing, step SP18 may be omitted so as to simply cause the belt waste toner collection container 33 to collect all the waste toners from the image formation units 12 with the drum waste toner collection containers 27 having less room than the belt waste toner collection container 33. In this case, the belt waste toner collection container 33 desirably has a larger capacity than the capacity of each drum waste toner collection container 27.

Meanwhile, without limitation to the foregoing, either the configuration to cause the belt waste toner collection container 33 to collect the waste toner only from the image formation unit 12 having the largest drum waste toner precedence rate out of the image formation units 12 with the drum waste toner collection containers 27 having less room than the belt waste toner collection container 33 or the configuration to cause the belt waste toner collection container 33 to collect all the waste toners from the image formation units 12 with the drum waste toner collection containers 27 having less room than the belt waste toner collection container 33 may be made selectable on the image formation apparatus 1 through the display unit 43 and the input unit 44, for example.

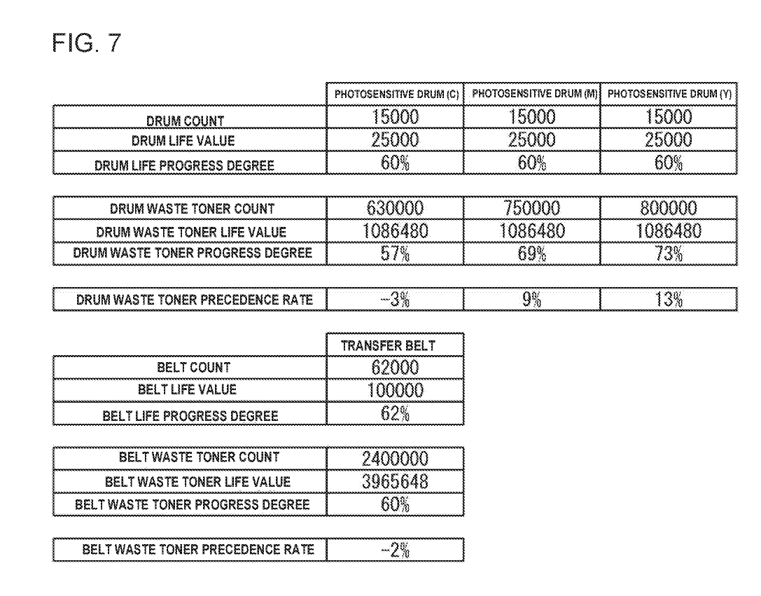

Now, the above-mentioned deteriorated toner disposal processing is more specifically described by using specific examples of numerical values. FIG. 7 represents an example of a state of the image formation apparatus 1 at a certain point of time. In this instance, the drum count of the photosensitive drum 20 included in the image formation unit 12C is 15000, the drum life value thereof is 25000, and the drum life progress degree thereof turns out to be 15000/25000×100=60%. Meanwhile, the drum count, the drum life value, and the drum life progress degree of the photosensitive drum 20 included in the image formation unit 12M are 15000, 25000, and 60%, respectively, and the drum count, the drum life value, and the drum life progress degree of the photosensitive drum 20 included in the image formation unit 12Y are also 15000, 25000, and 60%, respectively.

Moreover, the drum waste toner count of the drum waste toner collection container 27 included in the image formation unit 12C is 630000, the drum waste toner life value thereof is 1086480, the drum waste toner progress degree thereof turns out to be 630000/1086480×100=57%, and the drum waste toner precedence rate thereof turns out to be 57%-60%=−3%. In other words, these values signify that the usage rate of the drum waste toner collection container 27 has a margin of 3% relative to the wear rate of the photosensitive drum 20 in the image formation unit 12C.

Meanwhile, the drum waste toner count, the drum waste toner life value, the drum waste toner progress degree, and the drum waste toner precedence rate of the drum waste toner collection container 27 included in the image formation unit 12M are 750000, 1086480, 69%, and 9%, respectively. In other words, these values signify that the usage rate of the drum waste toner collection container 27 precedes the wear rate of the photosensitive drum 20 by 9% in the image formation unit 12M.

Moreover, the drum waste toner count, the drum waste toner life value, the drum waste toner progress degree, and the drum waste toner precedence rate of the drum waste toner collection container 27 included in the image formation unit 12Y are 800000, 1086480, 73%, and 13%, respectively. In other words, these values signify that the usage rate of the drum waste toner collection container 27 precedes the wear rate of the photosensitive drum 20 by 13% in the image formation unit 12Y.

In the meantime, the belt count of the transfer belt 30 included in the transfer unit 13 is 62000, the belt life value thereof is 100000, and the belt life progress degree thereof turns out to be 62000/100000×100=60%. Moreover, the belt waste toner count of the belt waste toner collection container 33 included in the transfer unit 13 is 2400000, the belt waste toner life value thereof is 3965648, the belt waste toner progress degree thereof turns out to be 2400000/3965648×100=60%, and the belt waste toner precedence rate thereof turns out to be 60%-62%=−2%. In other words, these values signify that the usage rate of the belt waste toner collection container 33 has a margin of 2% relative to the wear rate of the transfer belt 30 in the transfer unit 13.

Here, when the image formation unit 12C is the target for execution of the deteriorated toner disposal processing, the deteriorated toner is collected into the drum waste toner collection container 27 in the case of the image formation unit 12C since the belt waste toner precedence rate (−2%)>the drum waste toner precedence rate (−3%) holds true (in other words, the drum waste toner collection container 27 has more room than the belt waste toner collection container 33).

Meanwhile, when the image formation unit 12M is the target for execution of the deteriorated toner disposal processing, the deteriorated toner is collected into the drum waste toner collection container 27 in the case of the image formation unit 12M since the drum waste toner precedence rate (9%)>the belt waste toner precedence rate (−2%) holds true (in other words, the belt waste toner collection container 33 has more room than the drum waste toner collection container 27) but the drum waste toner precedence rate is not the largest.

Moreover, when the image formation unit 12Y is the target for execution of the deteriorated toner disposal processing, the deteriorated toner is collected into the belt waste toner collection container 33 in the case of the image formation unit 12Y since the drum waste toner precedence rate (13%)>the belt waste toner precedence rate (−2%) holds true (in other words, the belt waste toner collection container 33 has more room than the drum waste toner collection container 27) and the drum waste toner precedence rate is the largest.

### 4. SUMMARY AND EFFECTS

As described above, the image formation apparatus 1 is configured to acquire the drum waste toner precedence rates of the respective image formation units 12C, 12M, and 12Y and the belt waste toner precedence rate of the transfer unit 13 when one of the image formation units 12C, 12M and 12Y collectively constituting the integrated image formation unit PU is selected as the target for execution of the deteriorated toner disposal processing, and to determine the destination of collection of the waste toner (that is, the deteriorated toner) based on the drum waste toner precedence rates and the belt waste toner precedence rate thus acquired.

Specifically, when the belt waste toner precedence rate of the transfer unit 13 is larger than the drum waste toner precedence rate of the image formation unit 12 being the target for execution of the deteriorated toner disposal processing (the belt waste toner precedence rate the drum waste toner precedence rate), that is, when the drum waste toner collection container 27 has more room than the belt waste toner collection container 33 for collection of the waste toner, the image formation apparatus 1 is configured to determine the drum waste toner collection container 27 having more room as the destination of collection of the waste toner (the deteriorated toner) and to collect the waste toner into the drum waste toner collection container 27.

On the other hand, when the drum waste toner precedence rate of the image formation unit 12 being the target for execution of the deteriorated toner disposal processing is larger than the belt waste toner precedence rate of the transfer unit 13 (the drum waste toner precedence rate>the belt waste toner precedence rate), that is, when the belt waste toner collection container 33 has more room than the drum waste toner collection container 27 for collection of the waste toner, the image formation apparatus 1 compares the belt waste toner precedence rate of the image formation unit 12 being the target for execution of the deteriorated toner disposal processing with the belt waste toner precedence rates of the rest of the image formation units 12.

Then, the image formation apparatus 1 is configured to determine the belt waste toner collection container 33 as the destination of collection of the waste toner only when the image formation unit 12 being the target for execution of the deteriorated toner disposal processing has the largest belt waste toner precedence rate so as to collect the waste toner into the belt waste toner collection container 33, and to determine the drum waste toner collection container 27 as the destination of collection of the waste toner in other cases so as to collect the waste toner into the drum waste toner collection container 27.

In this way, the image formation apparatus 1 can cause the waste toner collection container (any of the drum waste toner collection containers 27 and the belt waste toner collection container 33) other than the waste toner collection container having the highest waste toner precedence rate (either the drum waste toner precedence rate or the belt waste toner precedence rate) to collect the waste toners as much as possible. Thus, it is possible to cause the respective waste toner collection containers to collect the waste toners as evenly as possible.

To put it the other way around, the image formation apparatus 1 can cause the waste toner collection container (any of the drum waste toner collection containers 27 and the belt waste toner collection container 33) not having the high waste toner precedence rate (either the drum waste toner precedence rate or the belt waste toner precedence rate) to collect the waste toners. Thus, it is possible to cause the respective waste toner collection containers to collect the waste toners as evenly as possible.

As a consequence, the image formation apparatus 1 can extend a period before each of the three drum waste toner collection containers 27 included in the integrated image formation unit PU and the belt waste toner collection container 33 included in the transfer unit 13 becomes full. Accordingly, it is possible to prolong time of replacement of each of the integrated image formation unit PU and the transfer unit 13 so as to make a usable period longer than a relevant period in the case of the related art.

### 5. ALTERNATE EMBODIMENTS

### 5-1. First Alternate Embodiment

In the above-described one or more embodiments, the image formation units 12C, 12M, and 12Y are integrated into the single integrated image formation unit PU which is provided in an attachable and detachable manner to the apparatus housing 2. Without limitation to the foregoing, the image formation units 12C, 12M, and 12Y may be provided in an attachable and detachable manner to the apparatus housing 2 as individual units subject to replacement (replacement units).

In this case, in the deteriorated toner disposal processing, the belt waste toner collection container 33 may be simply caused to collect the waste toner from the image formation unit 12 with the drum waste toner collection container 27 having less room than the belt waste toner collection container 33 while omitting step SP18 illustrated in FIG. 6.

Meanwhile, without limitation to the foregoing, instead of providing the integrated image formation unit PU with the three drum waste toner collection containers 27 in total corresponding to the image formation units 12C, 12M, and 12Y, respectively, the integrated image formation unit PU may include a single drum waste toner collection container (not illustrated) to be shared by the image formation units 12C, 12M, and 12Y. In this case, the image formation apparatus 1 includes the two waste toner collection containers in total, namely, the single drum waste toner collection container to be provided to the integrated image formation unit PU and the single belt waste toner collection container 33 provided to the transfer unit 13.

Meanwhile, in this case, the drum waste toner precedence rate may be defined as a difference between the drum waste toner progress degree of the single drum waste toner collection container provided to the integrated image formation unit PU and the most progressive drum life progress degree out of the respective drum life progress degrees of the image formation units 12C, 12M, and 12Y. Further in this case, in the deteriorated toner disposal processing, the belt waste toner collection container 33 of the transfer unit 13 may be simply caused to collect the waste toner when the drum waste toner collection container of the integrated image formation unit PU has less room than the belt waste toner collection container 33 while omitting step SP18 illustrated in FIG. 6.

### 5-2. Second Alternate Embodiment

Meanwhile, in the above-described one or more embodiments, the drum toner count representing the amount of the waste toner collected in each drum waste toner collection container 27 is calculated by using the dot count of the image data included in the print data, and the drum waste toner progress degree is calculated based on the drum waste toner count and the drum waste toner life value. Without limitation to the foregoing, each of the image formation units 12C, 12M, and 12Y may be provided with a drum waste toner amount detection unit such as a sensor to detect the amount of the waste toner collected in the corresponding drum waste toner collection container 27, and the drum waste toner progress degree may be calculated based on the amount of the waste toner detected with the drum waste toner amount detection unit and the capacity of the corresponding drum waste toner collection container 27, for instance. Alternatively, there may be provided a drum waste toner progress degree detection unit such as a sensor to detect a ratio of the amount of collected waste toner relative to the capacity of the corresponding drum waste toner collection container 27 (that is, the drum waste toner progress degree), for instance.

Moreover, in the above-described one or more embodiments, the belt toner count representing the amount of the waste toner collected in the belt waste toner collection container 33 is calculated by using the dot count of the deteriorated toner disposal pattern, and the belt waste toner progress degree is calculated based on the belt waste toner count and the belt waste toner life value. Without limitation to the foregoing, the transfer unit 13 may be provided with a belt waste toner amount detection unit such as a sensor to detect the amount of the waste toner collected in the belt waste toner collection container 33, and the belt waste toner progress degree may be calculated based on the amount of the waste toner detected with the belt waste toner amount detection unit and the capacity of the belt waste toner collection container 33, for instance. Alternatively, there may be provided a belt waste toner progress degree detection unit such as a sensor to detect a ratio of the amount of collected waste toner relative to the capacity of the belt waste toner collection container 33 (that is, the belt waste toner progress degree), for instance.

### 5-3. Third Alternate Embodiment

Furthermore, in the above-described one or more embodiments, at the time of the deteriorated toner disposal processing, the belt waste toner collection container 33 is determined as the destination of collection of the waste toner only for the image formation unit 12 having the largest drum waste toner precedence rate out of the image formation units 12 with the drum waste toner collection containers 27 having less room than the belt waste toner collection container 33 whereas the drum waste toner collection containers 27 of their own are determined as the destinations of collection of the waste toners for the rest of the image formation units 12.

Without limitation to the foregoing, the belt waste toner collection container 33 may be determined as the destination of collection of the waste toner only for the image formation unit 12 having the positive drum waste toner precedence rate (that is, the image formation unit 12 with the usage rate of its drum waste toner collection container 27 being larger than the wear rate of its photosensitive drum 20) out of the image formation units 12 with the drum waste toner collection containers 27 having less room than the belt waste toner collection container 33, or the belt waste toner collection container 33 may be determined as the destination of collection of the waste toner only for the image formation unit 12 having a large difference (such as 5% or above) between the drum waste toner precedence rate and the belt waste toner precedence rate out of the image formation units 12 with the drum waste toner collection containers 27 having less room than the belt waste toner collection container 33, for example.

Meanwhile, without limitation to the foregoing, the drum waste toner collection container 27 may be determined as the destination of collection of the waste toner for the image formation unit 12 having the negative drum waste toner precedence rate (that is, when the wear rate of its photosensitive drum 20 is larger than the usage rate of its drum waste toner collection container 27) no matter how large or small the drum waste toner precedence rate and the belt waste toner precedence rate are, and the destination of collection of the waste toner may be determined in accordance with the procedures illustrated in FIG. 6 only when the image formation unit 12 has the positive drum waste toner precedence rate, for example.

### 5-4. Fourth Alternate Embodiment

Moreover, in the above-described one or more embodiments, the belt waste toner count is increased when the toner removed from the transfer belt 30 by using the belt cleaning blade 32 is collected in the belt waste toner collection container 33 in the deteriorated toner disposal processing. Without limitation to the foregoing, if the image formation apparatus 1 has the chance of collecting the toner removed from the transfer belt 30 by using the belt cleaning blade 32 into the belt waste toner collection container 33 that serves as a developer collection container outside the deteriorated toner disposal processing, for example, the belt waste toner count may be increased every time the toner is collected therein. For instance, if the image formation apparatus 1 is provided with a density correction function to transfer a density correction image of each color onto the transfer belt 30 and to correct the density of each color by reading the transferred density correction image with a density correction sensor (not illustrated), then the belt waste toner count may be increased at the time of the density correction as well. Here, the amount of the toner to be removed from the transfer belt 30 by using the belt cleaning blade 32 at the time of the density correction may be calculated based on a dot count of each density correction image, for example.

Meanwhile, in the above-described one or more embodiments, the drum waste toner count is increased at the time of printing and at the time of the deteriorated toner disposal processing. Without limitation to the foregoing, if the image formation apparatus 1 has the chance of collecting the toner removed from each photosensitive drum 20 by using the cleaning blade 25 into the drum waste toner collection container 27 that serves as the developer collection container outside the time of printing and the time of the deteriorated toner disposal processing, for example, then the drum waste toner count may be increased every time the toner is collected therein.

### 5-5. Fifth Alternate Embodiment

Moreover, in the above-described one or more embodiments, this disclosure is applied to the image formation apparatus 1 which includes: the three image formation units 12C, 12M, and 12Y corresponding to cyan, magenta, and yellow, respectively; and the transfer unit 13. Without limitation to the foregoing, this disclosure is also applicable to an image formation apparatus having a different configuration from the image formation apparatus 1 as long as such an image formation apparatus includes units subject to replacement (replacement units) each provided with an expendable part and a developer collection container. For instance, this disclosure may be applied to an image formation apparatus including four image formation units corresponding to cyan, magenta, yellow, and black, respectively, and a transfer unit. Alternatively, this disclosure may be applied to an image formation apparatus including an intermediate transfer unit, which is configured to transfer a toner image formed with an image formation unit onto a transfer belt in order to convey the transferred toner image to a predetermined position, and then to transfer the toner image onto a medium P instead of transferring the toner image directly onto the medium P.

Furthermore, in the above-described one or more embodiments, this disclosure is applied to the image formation apparatus 1 having the color printer structure. Without limitation to the foregoing, this disclosure is applicable to an image formation apparatus like a facsimile machine or a multifunction printer, as long as such an image formation apparatus includes units subject to replacement (replacement units) each provided with an expendable part and a developer collection container.

### 5-6. Sixth Alternate Embodiment

Moreover, in the above-described one or more embodiments, the controller 40 is used as a specific example of a determination unit to determine a developer collection container serving as a developer collection destination. Without limitation of the foregoing, it is also possible to use a determination unit different from the controller 40 as long as such a determination unit is capable of determining a developer collection container serving as a developer collection destination. For example, the image formation apparatus 1 may be provided with a determination unit separately from the controller 40 to control the image formation device 41. Furthermore, in the above-described one or more embodiments, the waste toner precedence rate calculator 40C is used as a specific example of a precedence rate calculator to calculate the drum waste toner precedence rate as a developer collection precedence rate representing how much the drum waste toner progress degree as a collection container capacity progress degree precedes the drum life progress degree as an expendable part life progress degree. Without limitation to the foregoing, it is also possible to use a precedence rate calculator different from the waste toner precedence rate calculator 40C as long as such a precedence rate calculator is capable of calculating the developer collection precedence rate. For example, the image formation apparatus 1 may be provided with a precedence rate calculator separately from the controller 40.

### 5-7. Seventh Alternate Embodiment

It is to be further understood that this disclosure is not limited to the above-described one or more embodiments. Specifically, the scope of application of this disclosure encompasses other embodiments that combine part or all of the above-described one or more embodiments, and embodiments that extract part of the above-described embodiments.

This disclosure is broadly applicable to image formation apparatuses including printers, facsimile machines, multifunction printers, and the like.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. An image formation apparatus comprising:
replacement units, each being replaceable and including an expendable part and a developer collection container; and
a determination unit, wherein
the determination unit:
acquires an expendable part life progress degree representing a degree of progress in used amount of the expendable part relative to a product life of the expendable part and a collection container capacity progress degree representing a degree of progress in used amount of the developer collection container relative to a capacity of the developer collection container for each of the replacement units; and
determines a developer collection container as a developer collection destination out of the developer collection containers of the replacement units, based on the acquired expendable part life degrees and the acquired collection container capacity progress degrees.

2. The image formation apparatus according to claim 1, wherein
the determination unit includes a precedence rate calculator that calculates a developer collection precedence rate, which represents how much the collection container capacity progress degree precedes the expendable part life progress degree, for each of the replacement units, and
the determination unit determines the developer collection container as the developer collection destination out of the developer collection containers of the replacement units, based on the developer collection precedence rates calculated by the precedence rate calculator.

3. The image formation apparatus according to claim 2, wherein the determination unit determines the developer collection container in one of the replacement units with a lowest developer collection precedence rate as the developer collection destination out of the developer collection precedence rates of the developer collection containers of the replacement units.

4. The image formation apparatus according to claim 2, wherein
the replacement units include
an integrated image formation unit including image formation units integrated, each of which forms an image by using a developer, and
a transfer unit that transfers the images formed by the integrated image formation unit onto a medium,
each of the image formation units includes the expendable part and the developer collection container,
the transfer unit includes the expendable part and the developer collection container, and
when at least one of the image formation units becomes a target for collection of the developer, the determination unit calculates the developer collection precedence rates of the respective image formation units and the developer collection precedence rate of the transfer unit by using the precedence rate calculator, and determines any one of the developer collection container of the image formation unit being the target for collection of the developer and the developer collection container of the transfer unit as the developer collection destination based on the calculated developer collection precedence rates.

5. The image formation apparatus according to claim 4, wherein
the determination unit determines the developer collection container of the transfer unit as the developer collection destination only in a first case where the developer collection precedence rate of the transfer unit is below the developer collection precedence rate of the image formation unit being the target for collection of the developer and where the developer collection precedence rate of the image formation unit being the target for collection of the developer is the largest out of the developer collection precedence rates of the image formation units, and
the determination unit determines the developer collection container of the image formation unit being the target for collection of the developer as the developer collection destination in cases other than the first case.

6. The image formation apparatus according to claim 2, wherein
the replacement units include
image formation units each of which forms an image by using a developer, and
a transfer unit that transfers the images formed by the image formation units onto a medium,
each of the image formation units includes the expendable part and the developer collection container,
the transfer unit includes the expendable part and the developer collection container, and
when at least one of the image formation units becomes a target for collection of the developer, the determination unit calculates the developer collection precedence rates of the respective image formation units and the developer collection precedence rate of the transfer unit by using the precedence rate calculator, and determines any one of the developer collection container of the image formation unit being the target for collection of the developer and the developer collection container of the transfer unit as the developer collection destination based on the calculated developer collection precedence rates.

7. The image formation apparatus according to claim 6, wherein
the determination unit determines the developer collection container of the image formation unit being the target for collection of the developer as the developer collection destination in a case where the developer collection precedence rate of the transfer unit is equal to or above the developer collection precedence rate of the image formation unit being the target for collection of the developer, and
the determination unit determines the developer collection container of the transfer unit as the developer collection destination in a case where the developer collection precedence rate of the transfer unit is below the developer collection precedence rate of the image formation unit being the target for collection of the developer.

8. A method of determining a developer collection destination, comprising:
acquiring an expendable part life progress degree and a collection container capacity progress degree for each of replacement units each being replaceable and including an expendable part and a developer collection container, the expendable part life progress degree representing a degree of progress in used amount of the expendable part relative to a product life of the expendable part, the collection container capacity progress degree representing a degree of progress in used amount of the developer collection container relative to a capacity of the developer collection container; and
determining one of the developer collection containers as a developer collection destination based on the acquired expendable part life degrees and the acquired collection container capacity progress degrees.
